(19) United States
(12) Patent Application Publication
(10) Pub. No.: US 2014/0063260 A1
(43) Pub. Date: Mar. 6, 2014

(54) PYLON MOUNTED CAMERA SYSTEM

(71) Applicants: Bryan N. Bender, Grand Blanc, MI (US); Anthony Sangiovanni, Riverside, CT (US)

(72) Inventors: Bryan N. Bender, Grand Blanc, MI (US); Anthony Sangiovanni, Riverside, CT (US)

(21) Appl. No.: 13/603,055

(22) Filed: Sep. 4, 2012

(51) Int. Cl. H04N 7/18

(52) U.S. Cl. 348/157; 348/E07.085

(57) ABSTRACT

A video replay system provided for and constructed within an end zone pylon. The video replay pylon includes an inner sleeve that serves as a rigid structure for protecting the enclosed electronic components of the system, and an outer sleeve that provides padding and a weather-proof covering. The components mounted within the inner sleeve include one or more video cameras, an audio microphone, a wireless radio frequency (RF) transmitter and a battery. A wireless receiver receives signals from the transmitter and provides the video images and audio to a television production crew and to game officials, who may use the video images and audio to determine, for example, whether a touchdown has been scored.

### BACKGROUND OF THE INVENTION

1. Field of the Invention

This invention relates generally to a pylon mounted camera system for use on a football field and, more particularly, to an end zone pylon fitted with a video camera, an audio microphone, a wireless transmitter and a battery, such that the pylon camera system can record sound and video images directly in the plane of the goal line and transmit the audio and video signals to a receiver where they can be used by game officials and/or television broadcasters.

2. Discussion of the Related Art

In the game of football, a touchdown is scored when a player carries a football across a goal line. More specifically, the touchdown is scored when any part of the football “breaks the plane” of the goal line, where the plane refers to a vertical plane through the goal line. In football games, situations often arise where it is not clear whether the football broke the plane of the goal line, such as when a player's forward progress is stopped at or very near the goal line. Similar questions can also arise—such as whether a player was down before the football broke the plane, or whether a player had complete possession of the football when the football broke the plane.

Video-replay is used as an officiating tool in professional football games, where the game officials can review video images when the video images can be of assistance in making the right call. For example, video-replay is frequently used to determine if a player scores a touchdown, or if a player catches the football in bounds. It is common in National Football League (NFL) games to have many video cameras recording the game action. These cameras provide video images from many different perspectives, as there may be fixed/pivoting cameras in several locations, mobile cameras on trolleys which run up and down the sidelines, and even cameras mounted on elevated cables that track up and down the length of the field. However, there is rarely, if ever, a camera in a position to capture a video image aligned directly with the true plane of the goal line. Furthermore, out of position cameras that are not aligned to the goal line's plane would produce a skewed perspective that can make it impossible to absolutely determine if the football broke the plane of the goal line. A video camera located directly in the plane of the goal line would greatly assist in making the correct call. Sound clips recorded at or near the goal line can also be beneficial. For a game official to be able to hear when a whistle blows a play “dead” while watching the replay can also assist in making the correct call.

Football is also a very rough sport. Any object on or near the field of play is subject to experiencing very high impact forces. These impact forces can measure hundreds, if not thousands, of pounds, as one or more players can collide or fall to the ground while moving very fast. Thus, while there is a clear need for a video camera which provides images directly in the plane of the goal line, along with a microphone for recording sounds at or near the goal line, such a device must be rugged and reliable enough to withstand the punishment it will inevitably receive.

### SUMMARY OF THE INVENTION

In accordance with the teachings of the present invention, a video replay camera system provided in an end zone pylon is disclosed. The video camera pylon includes an inner sleeve that serves as a rigid structure for protecting the enclosed electronic components of the system, and an outer sleeve that provides padding and a weather-proof covering. The components mounted within the inner sleeve include one or more video cameras, a wireless transmitter, an audio microphone and a battery. A wireless receiver receives signals from the transmitter and provides the video images and audio to a television production crew and to game officials, who may use the video images and audio to determine, for example, whether a touchdown has been scored.

Additional features of the present invention will become apparent from the following description and appended claims, taken in conjunction with the accompanying drawings.

### BRIEF DESCRIPTION OF THE DRAWINGS

FIG. 1 is an illustration of a football field including a plurality of video replay pylons; and

FIG. 2 is an exploded illustration of one of the video replay pylons.

### DETAILED DESCRIPTION OF THE EMBODIMENTS

The following discussion of the embodiments of the invention directed to a video replay camera and audio microphone mounted in a football end zone pylon is merely exemplary in nature, and is in no way intended to limit the invention or its applications or uses.

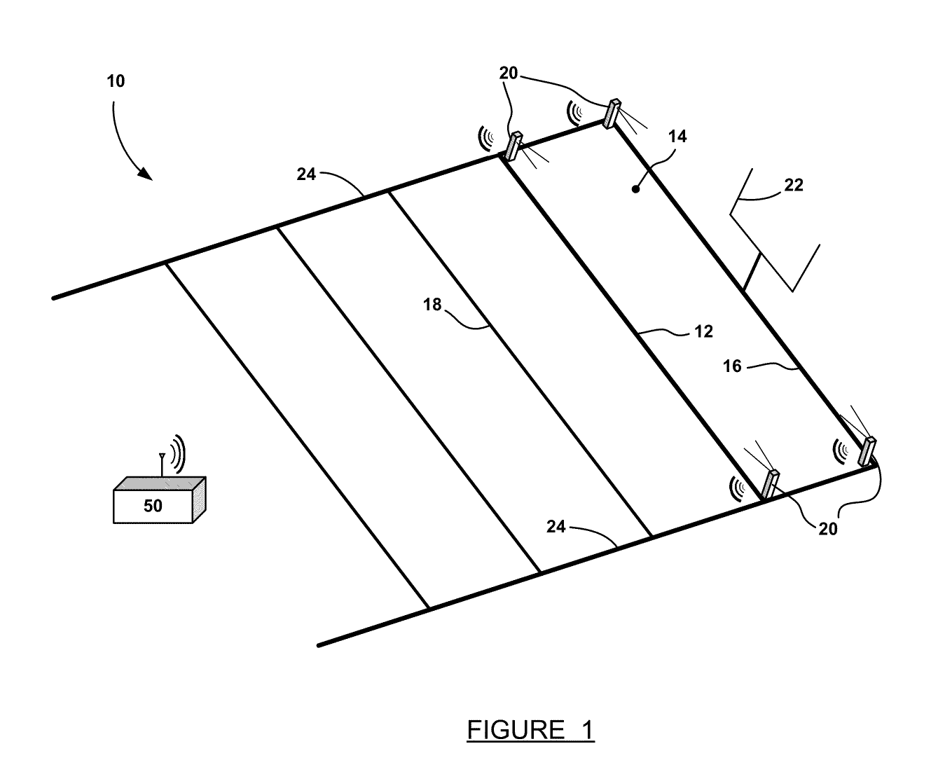

FIG. 1 is a partial illustration of a traditional football field 10 including yardage lines 18, side lines 24, a goal line 12, an end line 16, and a goal post 22, where an end zone 14 is provided between the goal line 12 and the end line 16. A plurality of rectangular shaped video replay pylons 20 are provided at each corner of the end zone 14, where the entire pylon 20 is completely positioned within the end zone 14. As mentioned above, the object of a football game is to carry a football across the goal line 12 into the end zone 14. In some situations, it may be difficult or impossible for game officials to determine whether the football has crossed the goal line 12. Specifically, a determination must be made whether the football broke the vertical plane containing the goal line 12, while the football carrier had possession and control of the football. The video replay pylons 20 can greatly assist in making this determination by providing video images and audio for instant replay, where the video images from the pylons 20 on the goal line 12 are in the true vertical plane of the goal line 12. The video replay pylons 20 on the end line 16 can be used to determine whether a player's feet or body touched in bounds while the player had possession and control of the football. Audio recorded from the vicinity of the end zone 14 can also augment the video images, by providing clear evidence of when an official's whistle was blown.

Goal line pylons are already used on football fields to provide a visual reference for the position of players in the corners of the end zone 14. The video replay pylons 20 can simply be used in place of the traditional goal line pylons. For reference, a traditional goal line pylon is rectangular in shape, is about 18-20 inches tall and about 4-5 inches thick in both horizontal directions. The video replay pylons 20 can be made the same size as a traditional goal line pylon, as advances in video cameras and wireless transmitters now make this compact size possible.

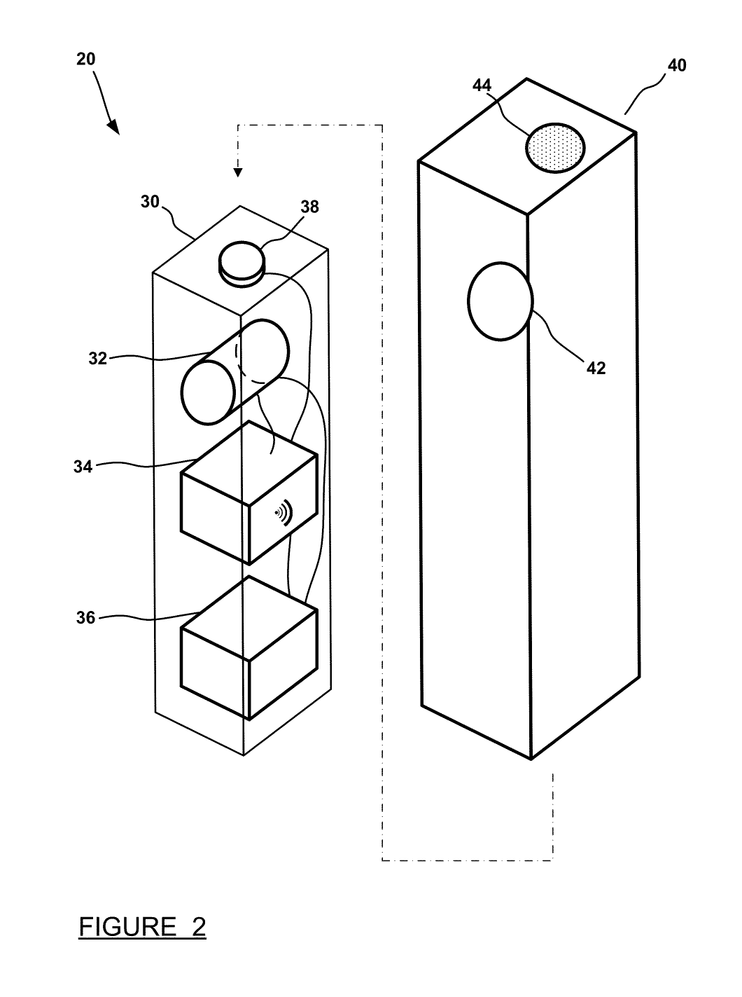

FIG. 2 is an exploded illustration of one of the video replay pylons 20. The pylon 20 includes an inner sleeve 30 that serves as a structural frame for the components within the pylon 20. The inner sleeve 30 could be made from a rigid, lightweight material such as ABS plastic, or from another structural plastic or composite material, among other things. The inner sleeve 30 could be of any design and shape suitable for the purpose of housing the components described below. For example, the inner sleeve 30 could be of a box-type construction with solid side walls, a honeycomb structure, or it could have a peripheral frame with open sides. In any case, the inner sleeve 30 provides rigid attachment points for the interior components, and also serves as a crush-resistant structure that protects the components from damage when impacted by a player or players during the course of a game.

Attached to the inner sleeve 30 is a camera 32. The camera 32 is preferably a high definition video camera with a fixed focal length lens. In one non-limiting embodiment, the camera 32 is an 10 Industries Flare 2KSDI video camera. Other makes and models may be used as appropriate, and different cameras may provide different advantages. It is also possible for the video replay pylon 20 to include more than one camera, where the different cameras could have different focal lengths, different aim directions, etc. For example, it can easily be envisioned to include two of the cameras 32 oriented along the goal line 12, and another of the cameras 32 oriented along the side line 24 in each direction.

Also attached to the inner sleeve 30 is a wireless transmitter 34, such as a 5.8 GHz COFDM transmitter. The wireless transmitter 34 receives signals containing video images from the camera(s) 32 and transmits the video images to a remote receiver. The wireless transmitter 34 preferably uses radio frequency (RF) wireless transmission. In one non-limiting embodiment, the wireless transmitter 34 is an RF Central MicroLite HD RF system. Other makes and models may be used as appropriate, and different wireless transmitters may provide different advantages.

A battery 36 is also mounted within the inner sleeve 30. The battery 36 provides power to the camera 32 and the wireless transmitter 34. The battery 36 should have sufficient capacity to power the video replay pylon 20 for at least half of a football game. At halftime, if necessary, the battery 36 in each of the video replay pylons 20 could be replaced with a fully charged replacement battery 36. Alternately, the entire video replay pylon 20 could be replaced with a different unit containing a fully charged battery 36. The battery 36 could either be rechargeable or non-rechargeable, with rechargeable being a preferred embodiment. In one non-limiting embodiment, the battery 36 is an Anton Bauer Hytron 120 battery. Other makes and models of batteries may be used as appropriate.

To facilitate quick replacement of the battery 36, it should be easily accessible within the inner sleeve 30. It is preferable to use a simple plug-in type attachment feature for the battery 36, rather than mounting screws. Alternatively, the battery 36 could be semi-permanently mounted in the inner sleeve 30, and a charging plug could be provided to recharge the battery 36 in place. Furthermore, it is preferable to mount the battery 36 near the bottom of the inner sleeve 30 to lower the center of gravity of the video replay pylon 20 as much as possible. A weight is used in traditional goal line pylons to lower the center of gravity and help the pylon stay in an upright position. The battery 36 can serve this same weighting function in the video replay pylon 20.

An audio microphone 38 is also mounted to the inner sleeve 30. The microphone 38 may be integrated with the video camera 32, or it may be a separate component as shown in FIG. 2. The microphone 38 is included to record nearby game audio, to augment the video replay images. The microphone 38 can be of any suitable type, including piezoelectric, condenser or parabolic types. In one embodiment, the microphone 38 is positioned on the top of the video replay pylon 20, so as to be able to record sounds emanating from any direction. This is important because game officials may be in almost any location—including on the playing field, in the end zone, or out of bounds—when they blow their whistle. In another embodiment, more than one of the microphones 38 may be provided, such as on two or more sides of the video replay pylon 20. The microphone 38 provides audio signals to the wireless transmitter 34, and the audio signals are also transmitted to the remote receiver.

An outer sleeve 40 fits over the inner sleeve 30. The outer sleeve 40 serves as a weather-proof covering for the components in the inner sleeve 30, and also provides cushioning to protect both the players and the interior components in the event a player impacts the video replay pylon 20. The outer sleeve 40 may preferably be constructed of a high-density foam material covered with vinyl or similar material. The outer sleeve 40 includes a port hole 42 that is aligned with the camera lens to provide the camera 32 with a clear line of sight to the goal line plane. Additional port holes would be provided if more than one of the cameras 32 is used. The outer sleeve 40 also includes an aperture 44 adjacent the microphone 38, where the aperture 44 allows sound to reach the microphone 38 with minimal attenuation. The aperture 44 could be designed to prevent water from entering the video replay pylon 20 while still allowing sound waves to pass through, such as by using a low density foam covered with a thin plastic film.

The inner sleeve 30 and the outer sleeve 40 have a size relative to each other so that the outer sleeve 40 fits over the inner sleeve 30 by sliding it down vertically from above, as shown in FIG. 2, so that the inner sleeve 30 fills the entire volume of the outer sleeve 40 in a “snug” fit. Other methods of fitting the outer sleeve 40 over the inner sleeve 30 may also be suitable, such as wrapping the outer sleeve 40 over the inner sleeve 30 and securing the outer sleeve 40 with a hook-and-loop or Velcro® type fastener.

As part of a complete video reply system, a wireless receiver 50 (FIG. 1) is also provided, such as a two-way diversity COFDM receiver. The receiver 50 receives video images from the wireless transmitter 34 in the video replay pylon 20. The wireless receiver 50 provides the video images and audio to the game officials for their review as needed, such as during video replay or coaches' challenge calls. The video images and audio are also provided for television broadcast. The distribution and use of the video images and audio from the video replay pylon 20 via the receiver 50 would be handled in the manner typically employed at a football game with multiple cameras and microphones, with the television production crew in coordination with the football league officials.

In a typical installation, four or eight of the video replay pylons 20 would be used on the football field 10. That is, one video replay pylon 20 would be provided at each end of each of the two goal lines 12. Additionally, a video replay pylon 20 could be provided at each end of each of the two end lines 16. The wireless transmitter 34 in each video replay pylon 20 could be configured to operate on a different frequency from the others, or signal modulation or coding could be used to allow the video signals from the multiple video replay pylons 20 to be distinguished. Such technology would be well known by those skilled in the art, such as television sports production crews.

It may also be advantageous to allow commands to be sent to the video replay pylon 20. For example, it may be desirable to have the video replay pylon 20 in a standby mode until a game starts. In the standby mode, the camera 32 would not record images, the microphone 38 would not capture audio, and the transmitter 34 would not transmit data, thus conserving battery power. At game time, a command could be sent to the video replay pylon 20 to switch to an active mode, where video images and audio are recorded and transmitted. To implement such a capability, the wireless transmitter 34 could be a transceiver with both transmitting and receiving capability. In addition, the wireless transmitter 34 could be capable of processing commands and controlling the components of the video replay pylon 20. Optionally, a separate processor component (not shown) could be added to the video replay pylon 20, to provide additional processing and configuration capability.

Professional football is big business. If a bad call is made by a game official, the consequences for the teams can be enormous. The video replay pylon 20 can provide video images and audio that assist game officials in making the right call, and is designed to be rugged and reliable enough to endure the punishment it will receive on the football field, while constructed in a manner to also maintain player safety.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A pylon video replay system comprising:
an inner sleeve;
a video camera attached to the inner sleeve;
an audio microphone attached to the inner sleeve;
a wireless transmitter attached to the inner sleeve and receiving video signals from the video camera and audio signals from the microphone, said transmitter wirelessly transmitting the video signals and the audio signals;
a battery attached to the inner sleeve and providing electrical power to the video camera and the wireless transmitter; and
an outer sleeve configured to fit over the inner sleeve including the video camera, the microphone, the wireless transmitter and the battery.

2. The system according to claim 1 wherein the microphone is attached to a top surface of the inner sleeve, and the outer sleeve includes an aperture adjacent the microphone suitable to allow sounds coming from any direction to reach the microphone.

3. The system of claim 1 further comprising a wireless receiver, said wireless receiver receiving the video signals and the audio signals from the wireless transmitter.

4. The system of claim 1 wherein the inner sleeve has a rigid structure that protects the video camera, the microphone, the wireless transmitter and the battery from impact forces.

5. The system of claim 4 wherein the inner sleeve is constructed from ABS plastic or other composite material.

6. The system of claim 1 wherein the outer sleeve includes a weatherproof covering.

7. The system of claim 1 wherein the outer sleeve includes a foam padding layer.

8. The system of claim 1 further comprising one or more additional video cameras and one or more additional microphones.

9. The system of claim 1 wherein the wireless transmitter is configured to receive wireless signals to control operation of the pylon video replay system.

10. The system according to claim 1 wherein the outer sleeve has a size and shape effective to act as an end zone pylon marker on a football field.

11. The system according to claim 1 wherein the outer sleeve has a rectangular shape.

12. A pylon video replay system comprising:
an inner sleeve comprising a rigid structure which protects components mounted within from impact forces from one or more football players;
a video camera attached within the inner sleeve;
an audio microphone attached to the inner sleeve;
a radio frequency (RF) transmitter attached within the inner sleeve and receiving video signals from the video camera and audio signals from the microphone, said transmitter wirelessly transmitting the video signals and the audio signals;
a battery attached within the inner sleeve and providing electrical power to the video camera and the RF transmitter; and
an outer sleeve configured to fit over the inner sleeve and the video camera, the microphone, the RF transmitter and the battery, where the outer sleeve includes a foam padding layer and a weatherproof covering.

13. The system of claim 12 further comprising a wireless receiver, said wireless receiver receiving the video signals and the audio signals from the RF transmitter.

14. The system of claim 12 further comprising one or more additional video cameras and/or one or more additional microphones.

15. The system of claim 12 wherein the RF transmitter is part of a transceiver that is configured to receive wireless signals to control operation of the video replay system.

16. The system according to claim 12 wherein the outer sleeve has a size and shape effective to act as an end zone pylon marker on a football field.

17. The system according to claim 12 wherein the microphone is attached to a top surface of the inner sleeve, and the outer sleeve includes an aperture adjacent the microphone suitable to allow sounds coming from any direction to reach the microphone.

18. A video replay pylon having a size and shape effective to act as an end zone marker on a football field, said pylon comprising:
an inner sleeve;
a video camera mounted to the inner sleeve;
an audio microphone mounted to the inner sleeve;
a wireless transmitter mounted to the inner sleeve and receiving video signals from the video camera and audio signals from the microphone, said transmitter wirelessly transmitting the video signals and the audio signals;
a battery mounted to the inner sleeve and providing electrical power to the video camera and the wireless transmitter, wherein the inner sleeve has a rigid structure that is effective to protect the video camera, the microphone, the wireless transmitter and the battery from impact forces from one or more football players; and
a rectangular shaped outer sleeve configured to fit over the inner sleeve including the video camera, the microphone, the wireless transmitter and the battery, wherein the outer sleeve includes a foam padding layer and a weatherproof covering, wherein the microphone is attached to a top surface of the inner sleeve, and the outer sleeve includes an aperture adjacent the microphone suitable to allow sounds coming from any direction to reach the microphone.

19. The pylon of claim 18 wherein the inner sleeve is constructed from ABS plastic or other composite material.

20. The pylon of claim 18 wherein the wireless transmitter is part of a transceiver that is configured to receive wireless signals to control operation of the video replay pylon and its components.
